(19) United States
(12) Patent Application Publication
(10) Pub. No.: US 2005/0076055 A1
(43) Pub. Date: Apr. 7, 2005

(54) Automatic question formulation from a user selection in multimedia content

(76) Inventors: Benoit Mory, Paris (FR); Franck Laffargue, Poissy (FR)

Correspondence Address: Corporate Patent Counsel;Philips Electronics North America Corporation, Po Box 3001, Briarcliff Manor, NY, 10510, US

(21) Appl. No.: 10/487,734

(22) PCT Filed: Aug. 22, 2002
(86) PCT No.: PCT/IB02/03464

(30) Foreign Application Priority Data
Aug. 28, 2001 (FR) 0111184

(51) Int. Cl. G06F 17/00

(52) U.S. Cl. 707/104.1

(57) ABSTRACT

The invention notably has for its object to permit a user who uses multimedia content to make a search for an object of interest evoked in said content, without having to formulate the question himself. For this purpose, a selection tool (for example, a key) permits the user to select a passage of the content while he is using it. When the user makes a selection, a context data is extracted from the content (for example, the current reading time). This context data is then used for recovering one or more descriptions in a document (for example, an MPEG-7 document) which describes said content. The recovered descriptions are finally used for automatically formulating a question intended to be transmitted to a search engine.

The invention relates to electronic equipment comprising reading means for reading a multimedia content which is described in a document containing descriptions. The invention also relates to a system comprising such equipment.

The invention likewise relates to a method of formulating a question intended to be transmitted to a search engine while a multimedia content is being used by a user, said multimedia content being described in a document that contains descriptions. The invention also relates to a program comprising program code instructions for implementing such a method when executed by a processor.

As indicated in the document “MPEG-7 Context, Objectives and Technical Roadmap” published by the ISO referred to as ISO/IEC JTC1/SC29/WG11/N2861, in July 1999, MPEG-7 is a standard for describing multimedia contents. A Multimedia content may be associated with an MPEG-7 document which describes said content, for example, to permit making searches in said multimedia content.

It is notably an object of the invention to propose a new application that utilizes an MPEG-7 document describing a multimedia content in view of searching for information.

Equipment according to the invention and as described in the opening paragraph is characterized in that it comprises a user command which permits a user to make a selection in said multimedia content, extraction means for extracting from said multimedia content one or more context data relating to said selection, means for recovering one or more descriptions in said document from said context data, and automatic formulation means based on recovered descriptions, of a question intended to be transmitted to a search engine.

The invention permits a user who is reading multimedia content to launch a search relating to that which he is reading in the multimedia content, without having to formulate himself the question to be transmitted to the search engine. In accordance with the invention the only thing that the user has to do is to make a selection in the multimedia content. This selection is then used automatically for formulating the question by using descriptions recovered from the document that describes the multimedia content.

Thanks to the invention the user thus:
neither has to choose keywords relevant for his search, which is generally complex enough (generally various attempts with various combinations of keywords are necessary for a non-specialist user to obtain a satisfactory result),
nor to seize keywords to be used for his search, which is difficult, if not impossible with equipment that has no alphabetic keyboard, for example, with a television decoder, a personal assistant, a mobile telephone . . . .

Moreover, the question posed being formulated from descriptions recovered from the document that describes the multimedia content, it is particularly relevant and it permits to obtain particularly good quality search results.

In a first embodiment of the invention the multimedia content contains a plurality of multimedia entities associated with a reading time, the document comprises descriptions relating to one or various multimedia entities which may be recovered from a reading time and the current reading time at the moment of the selection forms context information.

The multimedia content is formed, for example, by a video. When the user selects a video passage, for example, by depressing a key provided for this purpose, the current reading time of the video is recovered. This current reading time is used for finding the descriptions of the document that relate to the passage of the video selected by the user.

In a second embodiment of the invention the multimedia content contains objects identified by an object identifier, the document comprises descriptions relating to one or various objects that may be recovered from an object identifier, the user command comprises an object selection tool and the object identifier of the selected object forms context information.

The multimedia content is, for example, an image containing various objects that the user can select, for example, with the aid of a mouse-type selection tool, or with a stylus for a touch screen. When the user selects an object, the identifier of this object is recovered from the multimedia content and it is used for finding descriptions of the document that relate to the selected object.

In an advantageous manner said document is a tree structure of father and son nodes containing one or more descriptions that are instances of one or more descriptors, a description contained in a father node being valid for a son node when no other node from the father node to the son node contains another instance description of the same descriptor, and said description recovery means comparing the context information with instances of one or more descriptors called recovery descriptors for selecting a node in the tree-like structure, and recover other descriptions which are also valid for this node.

This embodiment is advantageous when the multimedia content is formed by a video and when the document is structured in the following fashion: the node of the first hierarchical level (root of the tree) corresponds to the complete video, the nodes of the second hierarchical level correspond to various scenes of the video, the nodes of the third hierarchical level correspond to the shots of the various scenes . . . . The descriptions which are valid for a father node are thus valid for its son nodes. The invention comprises searching for a start node, recovering other descriptions which are also valid for this start node, then going back in the tree step by step for recovering at each hierarchical level descriptions which are instances of descriptors for which no instance has yet been recovered. The start node is the node that contains the description which is an instance of the recovery descriptor and that matches with the context information.

By recovering descriptions from various tree nodes, the invention permits to refine a question and thus to better focus the search.

These and other aspects of the invention are apparent from and will be elucidated, by way of non-limitative example, with reference to the embodiment described hereinafter.

In the drawings:

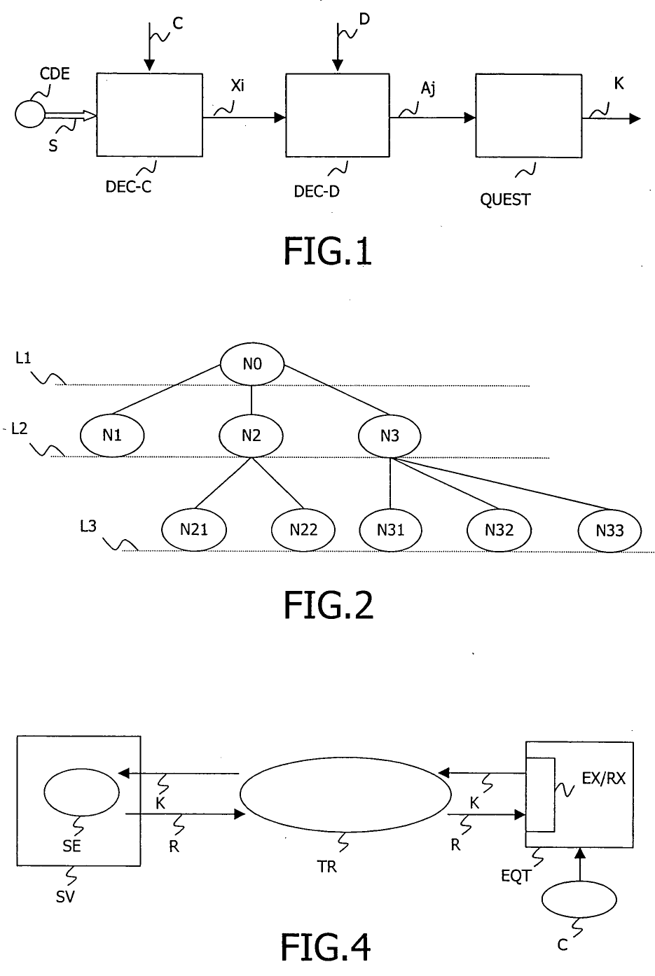

FIG. 1 is a block diagram of an example of equipment according to the invention,

FIG. 2 is a diagram of a tree-like structure of an example of a document according to the invention,

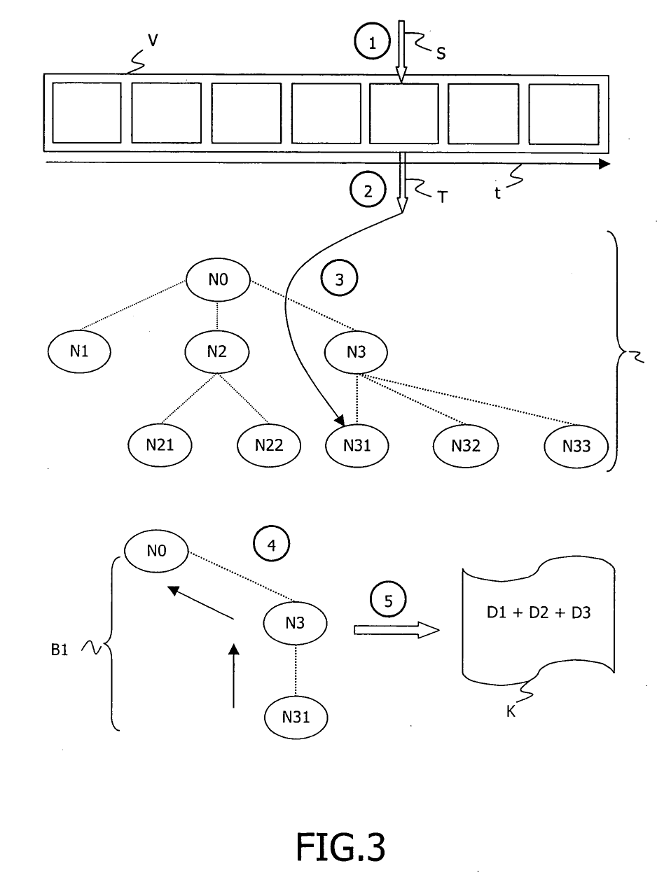

FIG. 3 is a diagram explaining the principle of the invention,

FIG. 4 is a functional diagram of an example of a system according to the invention.

In FIG. 1 is shown a functional diagram of an example of equipment according to the invention. According to FIG. 1 equipment according to the invention comprises:
a content reader DEC-C for reading multimedia content C,
a user command CDE for making a selection S from the multimedia content when the multimedia content C is being read,
a document reader DEC-D which receives, from the content reader DEC-C, one or more context data Xi relating to the selection S and which uses the context data Xi for reading a document D that describes the multimedia content C so as to supply descriptions Aj relating to this or these context data Xi,
a tool QUEST for automatically formulating a question to formulate a question K based on descriptions Aj read in the document D.

By way of example the multimedia content C is an MPEG-4 video, the content reader DEC-C is an MPEG-4 decoder, the document D is an MPEG-7 document and the document reader DEC-D is an MPEG-7 decoder.

When the multimedia content is a video, a reading time is associated with each image in the multimedia content. The user command is constituted, for example, by a simple button. When the user presses this button, the content reader DEC-C supplies the current reading time of the video (the current reading time is the reading time associated in the multimedia content with the image that is being read at the moment of the selection). This current reading time is then used as context information to find the descriptions of the document that relate to the passage of the video that is selected by the user.

When the multimedia content is an image that contains objects, an object identifier is associated with each object in the multimedia content. The user command is formed, for example, by a mouse. When the user selects an object of the image with the mouse, the content reader DEC-C supplies the object identifier that is associated to the selected object in the multimedia content. This object identifier is then used as context information to find the descriptions of the document that relate to the selected object.

When the multimedia content is a video of which certain images at least contain objects, the user command is, for example, a mouse which permits the user to select an object in an image of the video. When the user selects an object of an image of the video, the current reading time and the object identifier are advantageously used as context data.

In FIG. 2 is shown an example of a tree-like structure of a document D of multimedia content C. According to FIG. 2 this tree-like structure comprises:
a first hierarchical level L1 comprising a root node N0 which represents the whole the multimedia content,
a second hierarchical level L2 comprising three nodes N1 to N3 which represent a first, a second and a third part of the multimedia content respectively (for example, when the multimedia content is a video, each part corresponds to a different scene of the video),
a third hierarchical level L3 comprising two nodes N21 and N22 which are son nodes of the node N2, and three other nodes N31, N32 and N33 which are sons of the node N3. The nodes N21 and N22 represent a first and a second portion of the second part of the multimedia content, respectively. The nodes N31, N32 and N33 represent a first, a second and a third portion of the third part of the multimedia content. For example, when the multimedia content is a video, each portion corresponds to a shot of a scene of the video.

The nodes of the tree-like structure advantageously comprise descriptions which are instances of descriptors (a descriptor is a representation of a characteristic of all or part of the multimedia content). The context data must thus be such that they can be compared with the content of an instance of one of the descriptors used in the document that describes the multimedia content. The descriptors used for this comparison are called recovery descriptors.

The MPEG-7 standard defines a certain number of descriptors, notably a descriptor <<MediaTime>> which indicates the start time and end time of a video segment, as well as semantic descriptors, for example, the descriptors <<who>>, <<what>>, <<when>>, <<how>> . . . When the document used is an MPEG-7 document, the current reading time is advantageously used as context information and the content of the descriptions that are instances of the descriptor <<MediaTime>> is compared with the current reading time to find in the document the node corresponding to the selected segment. Then descriptions that are instances of the descriptors <<who>>, <<what>>, <<when>> and <<how>> are recovered for formulating the question.

The MPEG-4 and MPEG-7 standards also define object descriptors notably an object identification descriptor. The objects of a multimedia content are identified in said multimedia content by a description that is an instance of this object identification descriptor. This description is also contained in the MPEG-7 document. It can thus be used as context information when the user selects an object. In that case the recovery descriptor is formed by the object identification descriptor.

More generally, descriptions contained in a father node are also valid for its son nodes. For example, a description that is an instance of the descriptor <<where>>, relating to the whole video, remains valid for all the scenes and all the video shots. However, more precise descriptions, instances of the same descriptor, may be given for son nodes. These more precise descriptions are not valid for the whole video. For example, when the description <<France>> is valid for the whole video, the description <<Paris>> is valid for a scene SCENE1, and the descriptions <<Montmartre>> and <<Palais Royal>> are valid for a first and a second shot SHOT1 and SHOT2 of the scene SCENE1.

To be able to formulate precise questions, it is desired to use the most precise description for each available descriptor. Therefore, in an advantageous embodiment of the invention, the tree-like structure is passed through from a start node, son nodes to a father node. And for each hierarchical level, a description is only recovered if no other instance of the same descriptor has been recovered yet. If we take the previous example, when the user selects the shot SHOT1, it is the description <<Montmartre>> that is used for formulating the question. And when the user selects a third shot SHOT3 of the scene SCENE1, which does not contain an instance of the descriptor <<where>>, the description <<Paris>> is used.

In FIG. 3 is shown a diagram summarizing the detailed course of a method according to the invention of formulating a question intended to be transmitted to a search engine.

At step 1 the user presses the selection key CDE to select a passage of a video V. At step 2 the current reading time T at the moment of the selection is recovered. The current reading time T constitutes the context information. At step 3 the node that comprises an instance description of the recovery descriptor <<MediaTime>> containing a start time Ti and an end time Tf that define a time range in which the current reading time T is included is searched for in the document D. In FIG. 3, the node that matches this condition is node N31. At step 4 the branch B1 that carries the node N31 is passed through from the node N31 to the root N0 to recover the descriptions D1, D2 and D3 which are instances of the descriptors <<who>>, <<what>> and <<where>>. At step 5 the descriptions D1, D2 and D3 are used for generating a question K.

In FIG. 4 is represented an example of a system according to the invention. Such a system comprises a remote search engine SE accommodated on a server SV. It also comprises user equipment according to the invention referred to as EQT which permits a user to read multimedia content C, to make a selection from the multimedia content during the reading so as to launch a search for the selected passage. The equipment EQT comprises in addition to the elements already described with reference to FIG. 1 a transceiver EX/RX for transmitting a question K to the search engine SE and receiving a response R coming from the search engine SE. It finally comprises a transmission network TR for transmitting the question K and the response R.

In practice the invention is implemented by using software means. For this purpose equipment according to the invention comprises one or more processors and one or more program storage memories, said programs containing instructions for implementing functions that have just been described when they are executed by said processors.

The invention is independent of the video format used. By way of example it is notably applicable to the MPEG-1, MPEG-2 and MPEG4 formats.

1. Electronic equipment comprising reading means for reading a multimedia content which is described in a document containing descriptions, characterized in that it comprises a user command which permits a user to make a selection in said multimedia content, extraction means for extracting from said multimedia content one or more context data relating to said selection, means for recovering one or more descriptions in said document from said context data, and automatic formulation means based on recovered descriptions, of a question intended to be transmitted to a search engine.

2. Electronic equipment as claimed in claim 1, characterized in that said multimedia content contains a plurality of multimedia entities associated with a reading time, said document comprises descriptions relating to one or more multimedia entities which can be recovered from a reading time, and the current reading time (T) at the moment of the selection forms a context data.

3. Electronic equipment as claimed in claim 1, characterized in that said multimedia content contains objects identified by an object identifier, said document comprises descriptions relating to one or more objects that can be recovered by an object identifier, said user command comprises an object selection tool and the object identifier of the selected object forms a context data.

4. Electronic equipment as claimed in claim 1, characterized in that said document is a tree-like structure of father and son nodes (N0, N1, N2, N3, N21, N22, N31, N32, N33) containing one or various descriptions that are instances of one or more descriptors, a content description in a father node being valid for the son node when no other node from said father to said son node contains another description that is an instance of the same descriptor, and said description recovery means compare the context data with instances of one or more descriptors called recovery descriptors for selecting a node in the tree-like structure and recovering other descriptions which are also valid for this node.

5. A method of formulating a question intended to be transmitted to a search engine while a user is using a multimedia content, said multimedia content being described in a document that contains descriptions, characterized in that it comprises:
a selection step (1) by the user in said multimedia content,
an extraction step (2) for extracting from the multimedia content one or more context data relating to said selection,
a recovery step (3; 4) of one or more descriptions in said document from said context data and
an automatic formulation step (5) of said question from recovered descriptions.

6. A method as claimed in claim 5 of formulating a question, characterized in that said multimedia content contains a plurality of multimedia entities associated with a reading time, said document comprises descriptions relating to one or more of the media entities, which may be recovered from a reading time and in that the current reading time (T) constitutes context data at the moment of the selection (S).

7. A method as claimed in claim 5 of formulating a question, characterized in that said multimedia content contains objects identified by an object identifier, said document comprises descriptions relating to one or more objects which may be recovered by an object identifier, said selection step comprises an object selection and in that the object identifier of the selected object constitutes a context data.

8. A method as claimed in claim 5 of formulating a question, characterized in that said document is a tree-like structure of father and son nodes (N0, N1, N2, N3, N21, N22, N31, N32, N33) containing one or various descriptions that are instances of one or more descriptors, a content description in a father node being valid for the son node when no other node from said father to said son node contains another description that is an instance of the same descriptor, and said description recovery means compare the context data with instances of one or more descriptors called recovery descriptors for selecting a node in the tree-like structure and recovering other descriptions which are also valid for this node.

9. A program comprising program code instructions for implementing a method as claimed in claim 5, when it is executed by a processor.

10. A system comprising equipment (EQT) as claimed in claim 5 which comprises transceiver means (EX/RX) for transmitting said question to a remote search engine (SE) and for receiving a response (R) to said question coming from said remote search engine, a search engine (R) and transmission means (TR) for transmitting said question from the equipment to the search engine and for transmitting said response from the search engine to said equipment.
